(19) United States
(12) Patent Application Publication
(10) Pub. No.: US 2014/0341452 A1
(43) Pub. Date: Nov. 20, 2014

(54) SYSTEM AND METHOD FOR EFFICIENT ASSESSMENT OF LESION DEVELOPMENT

(71) Applicant: Siemens Medical Solutions USA, Inc., Malvern, PA (US)

(72) Inventors: Jens Kaftan, Oxford (GB); Matthew David Kelly, Botley (GB)

(73) Assignee: Siemens Medical Solutions USA, Inc., Malvern, PA (US)

(21) Appl. No.: 14/279,860

(22) Filed: May 16, 2014

(30) Foreign Application Priority Data
May 16, 2013 (GB) 1308866.1

(51) Int. Cl. G06T 7/00; G06T 7/40

(52) U.S. Cl. CPC G06T 7/0016; G06T 7/0097; G06T 7/408
USPC 382/130

(57) ABSTRACT

In a method for calculating and displaying a summary of changes in image-derived measurements of one or more properties of one or more regions of interest whereby a representation is presented to a user indicating a change in the property of at least one of the regions-of-interest, with an indication of the region-of-interest associated with the representation.

### BACKGROUND OF THE INVENTION

1. Field of the Invention

In follow-up oncology examinations the main medical question under scrutiny often is whether the patient's overall condition has been improved or has declined. This allows conclusions to be drawn on the effectiveness of treatment options and often influences the treatment planning. The present invention seeks to provide methods and apparatus to enable a user to compare results of two or more medical image scans, e.g. CT, MR, PET, or SPECT scans, acquired at different time-points. Such methods and apparatus may save time for the user, and supports the interpretation of the images.

2. Description of the Prior Art

In oncological follow-up examinations, a treating physician is required to quickly assess how the disease has developed since the previous scan. In the case of multiple lesions and/or metastases, collecting and interpreting the required information can be time-consuming. Moreover, in certain cases the development of lesions can differ in different regions. For example, after chemotherapy the primary tumor might show positive development, for example indicated by a reduction in PET tracer uptake, while a secondary tumor may have evolved, for example indicated by an increase in PET tracer uptake. Finally, the collected information might need to be effectively presented to a person without medical education.

In clinical practice, multiple time-points are either qualitatively or quantitatively compared using 2D and 3D representations of the acquired medical data (e.g. MPR slices or MIP renderings). In the use case of combined PET/CT examinations, a user may conventionally qualitatively compare lesions by visually comparing the uptake of the injected radiopharmaceutical in different VOIs. Particularly MIP representations of the acquired PET scan are helpful to get a good overview of the patient's condition. For quantitative comparisons, typically each lesion needs to be delineated and the resulting quantitative measurements of correlating lesions need to be compared. Finally, the user needs to mentally combine all available information, qualitative and quantitative, to draw a conclusion, for example for deciding on future treatment. This task may be further complicated if changes in measurements of response from different body regions are inconsistent over the timepoints considered.

A conventional approach to assessing potentially heterogeneous response is proposed by a system known as PERCIST. In PERCIST, a single representative lesion is selected per timepoint: specifically the lesion with the highest peak SUV. However, this approach is unable to take into account any inter-lesion or regional differences in response. Such differences may affect therapy selection, such as a choice of targets for targeted radiotherapy.

### SUMMARY OF THE INVENTION

The present invention accordingly provides an improved method and system for efficient assessment of lesion development.

The present invention describes a system and method to efficiently assess and visually represent a change in medical image data representing lesions. In preferred embodiments, a level of detail of the visualized comparison can be varied, such as from an individual lesion level to a view representing the overall condition of the patient. In certain embodiments, the invention provides a multi-level summary view representing the progress of tracer uptake in a patient, which may be used in the assessment of a progressive disease.

### BRIEF DESCRIPTION OF THE DRAWINGS

FIGS. 1A-1D respectively show visualizations of medical data representing lesions delineated in lungs and liver, and subjected to image treatment and rendering according to an embodiment of the present invention.

FIG. 2 schematically illustrates an embodiment of a system according to the present invention, realized as a computer system.

### DESCRIPTION OF THE PREFERRED EMBODIMENTS

The present invention provides a method for visually representing quantitative changes in image data such that a user can easily evaluate the qualitative and quantitative development of a represented feature such as a lesion.

The following definitions, acronyms, and abbreviations are used herein:

CT Computed tomography

MRI Magnetic resonance imaging

PET Positron emission tomography

SPECT Single-photon emission tomography

MIP Maximum intensity projection

MPR Multi-planar reformatting/reconstruction/rendering

VOI Volume of Interest

TP Time-point

CAD Computer-assisted diagnosis

NM Nuclear medicine

PERCIST PET Response Criteria in Solid Tumors

SUV Standardized Uptake Value.

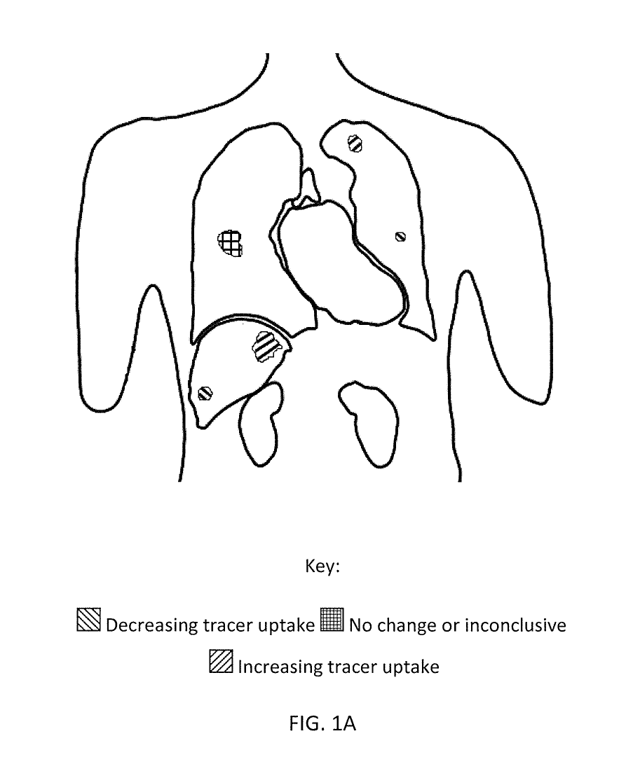

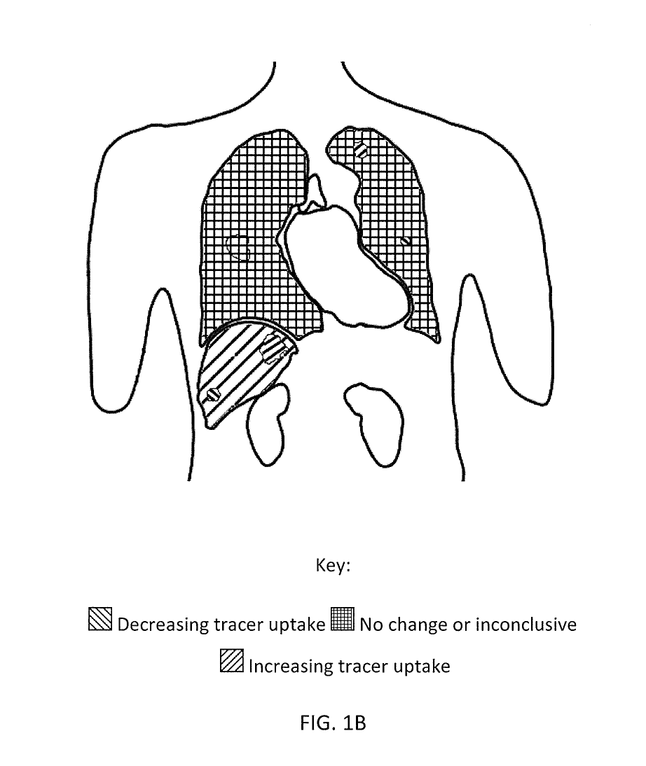

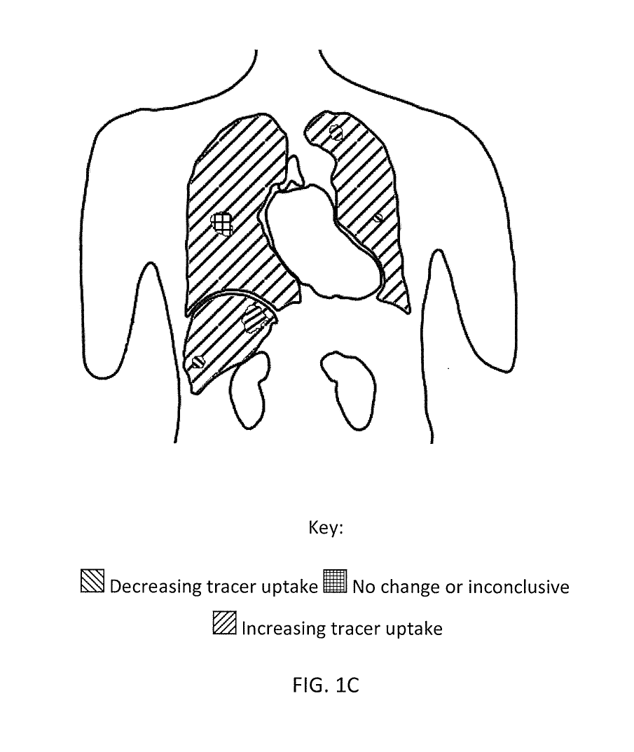

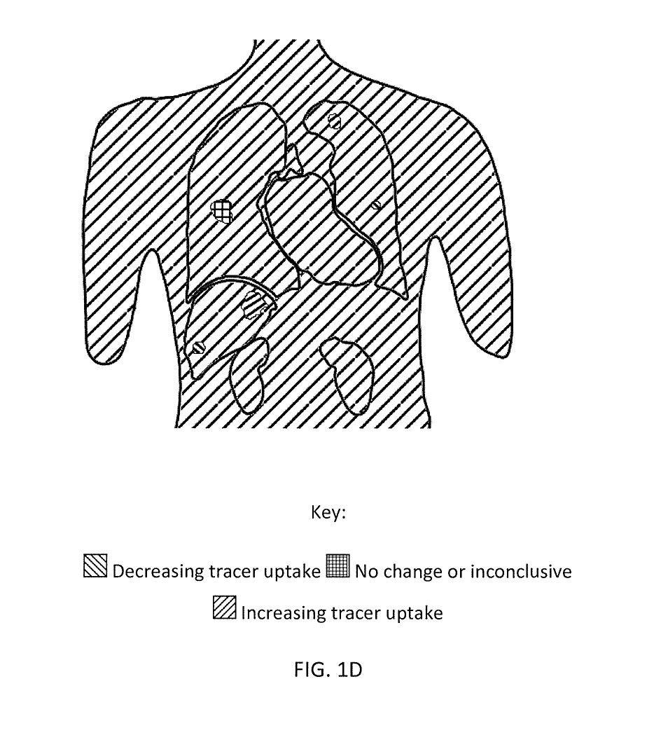

Each of FIGS. 1A-1D show five lesions delineated in lungs 3 and liver 2, shaded to illustrate changes in detected tracer uptake. The representation in each drawing shows an example visualization according to an embodiment of the present invention.

FIG. 1A illustrates quantitative measurements extracted from each lesion are used to determine whether the lesion has improved (represented by decreased tracer uptake) or progressed (represented by increased tracer uptake). In this embodiment, tumor progression is exemplarily highlighted on a per-lesion basis. It may be that a particular lesion shows no change, or the comparison may be inconclusive. The tumors are shown shaded according to the illustrated key, but may be color coded in example embodiments.

FIGS. 1B-1D illustrate overall changes from grouped lesions. FIGS. 1B and 1C illustrate a visualization representing development of lesions grouped according to an organ-basis. The progress on an organ-level is marked based on individual tumor change and volume. The organs may be identified in the image data in a segmenting operation, and the identified organ boundaries used to provide organ-based metrics. Left and right lungs are considered together as a single organ in this analysis.

FIG. 1C illustrates organ-based lesion change marked based on PERCIST-like criteria. If only a single representative lesion within an organ is marked as progressing, this status is used for highlighting the whole organ.

FIG. 1D represents a visualization representing development of lesions grouped for an overall patient view.

FIG. 1D represents an overall condition of the patient, which may be derived either from the representation of FIG. 1B: one organ with increased uptake and one inconclusive; or from the representation of FIG. 1C: two organs having increased tracer uptake.

In an example embodiment, the invention includes the following steps:

1. Extraction of quantitative measurements of correlated lesions from different time-points

2. Visual representation of change of one or more extracted measurements

3. Combination of multiple change measures into one visual representation based on anatomical information, e.g., organ segmentations

4. Opportunities for the user to interact with the system.

The present invention also provides a system for performing such methods. The system may be implemented in a computer.

The above steps and methods are detailed in the following subsections.

1. Extraction of Quantitative Measurements

In the first step of the example method given above, the user identifies one or more lesions in medical images from two or more time-points. These lesions can be manually identified, suggested by the system, or fully automatically identified by a CAD algorithm. Furthermore, representations of lesions can be identified on each medical image individually and linked between time-points by user action or automatically propagated from one timepoint to the other(s).

For each lesion, quantitative measurements are extracted such as lesion volume, mean/max intensity information, among others. Note that each time-point may combine information from multiple modalities, multiple scan protocols and reconstructions or in the case of NM from multiple tracers.

In the remainder of this document all examples will be simplified to the use-case of PET/CT examinations from two time-points with focus on quantitative PET measurements, as a non-limiting example sufficient to explain the invention when applied to any modality.

Not only lesions as a whole, but also sub-lesion measures can be extracted, evaluated and displayed according to the present invention. For example, CT-based necrosis analysis to extract the non-necrotic lesion fraction and only that fraction evaluated and displayed. Change in such quantitative measures can be evaluated and visualized according to the present invention.

2. Visual Representation of Change

Given a finding from two time-points, a qualitative notion of change can be extracted from quantitative measurements: whether the lesion has improved, such as may be expected following treatment; or has progressed. In PET imaging, a decreased maximum SUV measure could be used as indication of improvement while in CT imaging a reduced tumor size might be utilized for the same purpose. In general, a change in one measurement or a combination of multiple measurements, possibly extracted from different modalities, can be translated into the aforementioned notion of change.

This change is then visualized in combination with the tumor delineation. Example realizations to represent the change include, but are not limited to, color-coded contouring of the tumor, color-coded overlays, and color-coded silhouette visualizations in conjunction with volume rendering techniques, such as MIPs. An example is shown in FIG. 1A.

In a preferred realization, the visual representation of change is combined with volume rendering techniques, such that a user can evaluate all lesions in one glance and mentally combine the visual impression of the lesions from the simplified/reduced quantitative information extracted by comparing quantitative measurements.

### Visual Representation Based on Anatomical Information

Extracted change information can be combined into region-based visual representations using anatomical information. For instance, anatomical information may be augmented and used to classify each lesion according to its host organ and all change metrics within an organ of interest can be combined into one visual representation of change using a combination of measurements extracted from multiple lesions within the organ. Such combination may be weighted, for example to give extra weight to tracer count from a certain selected lesion. For the example of PET/CT studies, such anatomical information can be derived using CT-based organ segmentations (Kohlberger, et al. “Automatic Multi-Organ Segmentation Using Learning-based Segmentation and Level Set Optimization”, MICCAI 2012, Springer LNCS and US Patent Application 2012/0230572), or bone segmentations, PET-based organ segmentations or other body-region detection algorithms including the delineation of the whole body outline. Thus-defined change can then be visualized, but instead may be visualized on an organ, bone, body-region, or whole-body level, at the choice of the user such as illustrated in the example drawings of FIGS. 1B-1D.

3. Combination of Multiple Change Measures

A multitude of lesions can be combined into functional groups by either anatomical information or based on user interaction. As a consequence, the level of detail presented to the user is decreased.

Not only anatomical information such as organ delineations may be used to group different lesions but also any other arbitrary region may be employed, for example as defined on a reference volume serving as atlas. Alternatively, a user may arbitrarily assign selected lesions to a group, and development of the lesions within that group will be visualized and represented for a user to interpret.

A non-rigid registration can be used to identify lesions belonging to a particular group. In a similar manner, lesions may be grouped based on a corresponding host or neighboring tissue type, such as air (in lungs); fat; bone, etc. This information can be extracted using conventional image processing techniques. For instance in MR/PET, the Dixon scan protocol (MR) is commonly employed to segment the patient data into different tissue classes (Hoffmann, et al. “MRI-based attenuation correction for whole-body PET/MRI: quantitative evaluation of segmentation- and atlas-based methods”, J Nucl Med, 52(9), pp. 1392-9, 2011).

4. User Interaction

The invention further includes arrangements enabling a user to interact with the system. In one embodiment, the overall patient development may be viewed as a single representation, for example by a color-coded silhouette of the body outline visualized superimposed to the PET MIP, such as shown in FIG. 1D. By means of a user-interaction such as a mouse event, the level of detail can then be increased. For instance the next level of detail could show the above information further broken down based on anatomical organ segmentations. The level of detail can be further increased until each lesion is individually evaluated and visualized, with color coding or other suitable representation of the development of the respective lesion.

Although the present invention has been described with particular reference to lesions, it may be embodied so as to present information on the change of any characteristic of a human or animal subject.

Although the present invention has been described with reference to presenting the comparisons in graphical form using color coding, other arrangements may be employed, within the scope of the present invention. Rather than color, intensity or shading patterns may be used to signal the results of the comparison. Alternatively, the results may be presented in text form, either as labels on a graphical representation, or as a purely-text output, for example listing the names of various organs and the result of the comparison. In a top-level display, where an overall state of a patient is represented, the text output may comprise a patient's name or other identifier, and a text-based indication of the outcome of the comparison.

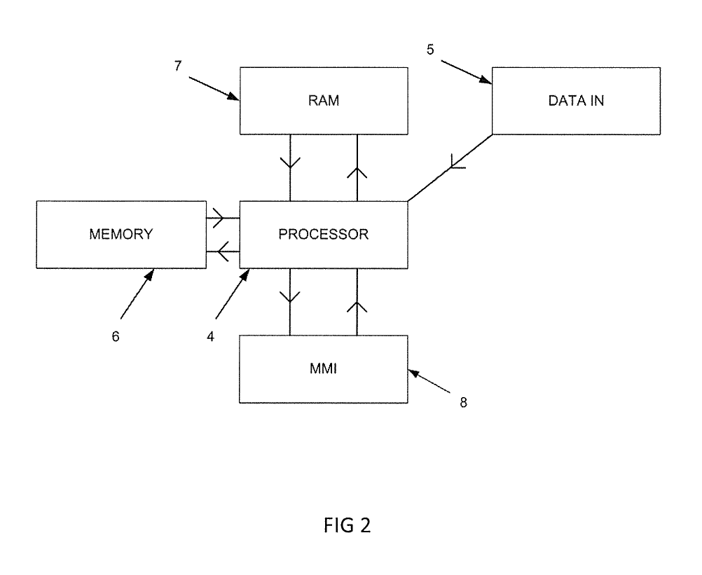

Referring to FIG. 2, embodiments of the invention may be conveniently realized as a computer system suitably programmed with instructions for carrying out the steps of the methods according to the invention.

For example, a central processing unit 4 is able to receive data representative of medical scans via a port 5 which could be a reader for portable data storage media (e.g. CD-ROM); a direct link with apparatus such as a medical scanner (not shown) or a connection to a network.

For example, in an embodiment, the processor performs such steps as: capturing medical image data of a patient at at least two different timepoints, said data representing a property of each of the at least one region-of-interest at each of the timepoints; comparing the data representing a corresponding region-of-interest at the different timepoints; and presenting a representation to a user indicating a change in the property of at least one of the regions-of-interest, with an indication of the region-of-interest associated with the representation.

Software applications loaded on memory 6 are executed to process the image data in random access memory 7.

A Man-Machine interface 8 typically includes a keyboard/mouse/screen combination to allow user input such as initiation of applications, and a screen on which the results of executing the applications are displayed.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for calculating and presenting a summary of changes in an image-derived measurement of at least one property of at least one region-of-interest of a subject, comprising:
providing a computerized processor with at least first medical image data acquired from a subject at a first point in time and comprising at least one region-of-interest of the subject, and second medical image acquired from the subject at a second point in time and comprising said at least one region-of-interest, said first medical image data representing a property of said at least one region-of-interest at said first point in time and second medical image data representing said property of said at least one region-of-interest at said second point in time;
in said processor, automatically comparing said property in said region-of-interest represented in said first medical image data with said property in said region-of-interest represented in said second medical image data, and thereby generating a comparison result; and
from an output of said processor, providing a humanly perceptible representation of a change in said property in said at least one region-of-interest, determined from said comparison result, together with a designation of said at least one region-of-interest in which said change exists.

2. A method as claimed in claim 1, comprising, in said processor, determining said at least one region-of-interest in each of said first medical image data and second medical image data by executing a segmentation algorithm.

3. A method as claimed in claim 1 comprising providing said processor with first medical image data that comprise a plurality of regions of interest and second medical image data that comprise said plurality of regions of interest, and comparing said plurality of regions of interest in said first medical image data with said plurality of regions of interest in said second medical image data to obtain a comparison result for each of said regions of interest, and providing said humanly perceptible representation of said change as a single humanly perceptible representation of said change for said plurality of regions of interest.

4. A method as claimed in claim 1 comprising providing said processor with first medical image data that comprise a plurality of regions of interest and second medical image data that comprise said plurality of regions of interest, and comparing said plurality of regions of interest in said first medical image data with said plurality of regions of interest in said second medical image data to obtain a comparison result for each of said regions of interest, and allowing manual selection, via a user interface in communication with said processor, of a level of detail of said humanly perceptible representation of said change, selected from the group consisting of whether each region-of-interest is individually represented with an individual comparison result thereof, or whether a single comparison result is presented for all of said regions of interest.

5. A method as claimed in claim 1 comprising providing said humanly perceptible representation of said change at a display in communication with said processor, by depicting said region-of-interest at said display with color coding representing a degree of said change determined from said comparison result.

6. A method as claimed in claim 1 comprising providing said processor with said first medical image data and said second medical image data wherein said at least one region-of-interest represents a lesion in said subject.

7. A method for calculating and presenting a summary of changes in an image-derived measurement of at least one property of at least one region-of-interest of a subject, comprising:
providing a computerized processor with at least first medical image data acquired from a subject at a first point in time and comprising at least one region-of-interest of the subject, and second medical image acquired from the subject at a second point in time and comprising said at least one region-of-interest, said first medical image data representing a property of said at least one region-of-interest at said first point in time and second medical image data representing said property of said at least one region-of-interest at said second point in time;
in said processor, automatically comparing said property in said region-of-interest represented in said first medical image data with said property in said region-of-interest represented in said second medical image data, and thereby generating a comparison result;
in said processor, implementing a segmentation algorithm to identify edges of organs in one of said first medical image data or said second medical image data; and
from an output of said processor, providing a visual representation of a change in said property in said at least one region-of-interest, determined from said comparison result, together with a designation of said at least one region-of-interest in which said change exists, also with a depiction of said organ at a position in said subject relative to a position of the region of interest in said subject.

8. A method as claimed in claim 7 comprising providing said processor with first medical image data that comprise a plurality of regions of interest and second medical image data that comprise said plurality of regions of interest, and comparing said plurality of regions of interest in said first medical image data with said plurality of regions of interest in said second medical image data to obtain a comparison result for each of said regions of interest, and providing said humanly perceptible representation of said change as a single humanly perceptible representation of said change for said plurality of regions of interest.

9. A method as claimed in claim 8 comprising providing said processor with first medical image data that comprise a plurality of regions of interest and second medical image data that comprise said plurality of regions of interest, and comparing said plurality of regions of interest in said first medical image data with said plurality of regions of interest in said second medical image data to obtain a comparison result for each of said regions of interest, and allowing manual selection, via a user interface in communication with said processor, of a level of detail of said humanly perceptible representation of said change, selected from the group consisting of whether each region-of-interest is individually represented with an individual comparison result thereof, or whether a single comparison result is presented for all of said regions of interest, or whether said change is presented for each organ.

10. A method as claimed in claim 7 comprising providing said humanly perceptible representation of said change at a display in communication with said processor, by depicting said region-of-interest at said display with color coding representing a degree of said change determined from said comparison result.

11. A method as claimed in claim 7 comprising providing said processor with said first medical image data and said second medical image data wherein said at least one region-of-interest represents a lesion in said subject.

12. A method for calculating and presenting a summary of changes in an image-derived measurement of at least one property of at least one region-of-interest of a subject, comprising:
providing a computerized processor with at least first medical image data acquired from a subject at a first point in time and comprising at least one region-of-interest of the subject, and second medical image acquired from the subject at a second point in time and comprising said at least one region-of-interest, said first medical image data representing a property of said at least one region-of-interest at said first point in time and second medical image data representing said property of said at least one region-of-interest at said second point in time;
in said processor, automatically comparing said property in said region-of-interest represented in said first medical image data with said property in said region-of-interest represented in said second medical image data, and thereby generating a comparison result;
in said processor, implementing a segmentation algorithm to identify outline of a tissue type in one of said first medical image data or said second medical image data; and
from an output of said processor, providing a visual representation of a change in said property in said at least one region-of-interest, determined from said comparison result, together with a designation of said at least one region-of-interest in which said change exists, also with a depiction of said tissue type at a position in said subject relative to a position of the region of interest in said subject.

13. A method as claimed in claim 12 comprising providing said processor with first medical image data that comprise a plurality of regions of interest and second medical image data that comprise said plurality of regions of interest, and comparing said plurality of regions of interest in said first medical image data with said plurality of regions of interest in said second medical image data to obtain a comparison result for each of said regions of interest, and providing said humanly perceptible representation of said change as a single humanly perceptible representation of said change for said plurality of regions of interest.

14. A method as claimed in claim 13 comprising providing said processor with first medical image data that comprise a plurality of regions of interest and second medical image data that comprise said plurality of regions of interest, and comparing said plurality of regions of interest in said first medical image data with said plurality of regions of interest in said second medical image data to obtain a comparison result for each of said regions of interest, and allowing manual selection, via a user interface in communication with said processor, of a level of detail of said humanly perceptible representation of said change, selected from the group consisting of whether each region-of-interest is individually represented with an individual comparison result thereof, or whether a single comparison result is presented for all of said regions of interest, or whether said change is presented for each tissue type.

15. A method as claimed in claim 12 comprising providing said humanly perceptible representation of said change at a display in communication with said processor, by depicting said region-of-interest at said display with color coding representing a degree of said change determined from said comparison result.

16. A method as claimed in claim 12 comprising providing said processor with said first medical image data and said second medical image data wherein said at least one region-of-interest represents a lesion in said subject.

17. A system for calculating and displaying a summary of changes in an image-derived measurement of at least one property of at least one region-of-interest of a subject, comprising:
a computerized processor having an input that receives at least first medical image data acquired from a subject at a first point in time and comprising at least one region-of-interest of the subject, and second medical image acquired from the subject at a second point in time and comprising said at least one region-of-interest, said first medical image data representing a property of said at least one region-of-interest at said first point in time and second medical image data representing said property of said at least one region-of-interest at said second point in time;
said processor being configured to automatically compare said property in said region-of-interest represented in said first medical image data with said property in said region-of-interest represented in said second medical image data, and thereby generating a comparison result;
a display in communication with said processor; and
said processor being configured to provide a visual representation of a change in said property in said at least one region-of-interest, determined from said comparison result, at said display, together with a designation of said at least one region-of-interest in which said change exists.

18. A system for calculating and displaying a summary of changes in an image-derived measurement of at least one property of at least one region-of-interest of a subject, comprising:
a computerized processor having an input that receives at least first medical image data acquired from a subject at a first point in time and comprising at least one region-of-interest of the subject, and second medical image acquired from the subject at a second point in time and comprising said at least one region-of-interest, said first medical image data representing a property of said at least one region-of-interest at said first point in time and second medical image data representing said property of said at least one region-of-interest at said second point in time;
said processor being configured to automatically compare said property in said region-of-interest represented in said first medical image data with said property in said region-of-interest represented in said second medical image data, and thereby generating a comparison result;
said processor being configured to implement a segmentation algorithm to identify edges of organs in one of said first medical image data or said second medical image data;
a display in communication with said processor; and
said processor being configured to provide a visual representation of a change in said property in said at least one region-of-interest, determined from said comparison result, at said display, together with a designation of said at least one region-of-interest in which said change exists, also with a depiction of said organ at a position in said subject relative to a position of the region of interest in said subject.

19. A method for calculating and displaying a summary of changes in an image-derived measurement of at least one property of at least one region-of-interest of a subject, comprising:
a computerized processor having an input that receives at least first medical image data acquired from a subject at a first point in time and comprising at least one region-of-interest of the subject, and second medical image acquired from the subject at a second point in time and comprising said at least one region-of-interest, said first medical image data representing a property of said at least one region-of-interest at said first point in time and second medical image data representing said property of said at least one region-of-interest at said second point in time;
said processor being configured to automatically compare said property in said region-of-interest represented in said first medical image data with said property in said region-of-interest represented in said second medical image data, and thereby generating a comparison result;
said processor being configured to implement a segmentation algorithm to identify outline of a tissue type in one of said first medical image data or said second medical image data;
a display in communication with said processor; and
said processor being configured to provide a visual representation of a change in said property in said at least one region-of-interest, determined from said comparison result, at said display, together with a designation of said at least one region-of-interest in which said change exists, also with a depiction of said tissue type at a position in said subject relative to a position of the region of interest in said subject.
